(19) United States
(12) Patent Application Publication
(10) Pub. No.: US 2025/0124937 A1
(43) Pub. Date: Apr. 17, 2025

(54) AUDIO MANIPULATION OF EMULATED CONTENT

(71) Applicant: Motorola Mobility LLC, Chicago, IL (US)

(72) Inventors: Amit Kumar Agrawal, Bangalore (IN); Satyabrata Rout, Bangalore (IN); Himanshu Chug, Bangalore (IN)

(73) Assignee: Motorola Mobility LLC, Chicago, IL (US)

(21) Appl. No.: 18/487,419

(22) Filed: Oct. 16, 2023

(51) Int. Cl. G10L 21/013; G10L 25/90

(52) U.S. Cl. CPC G10L 21/013; G10L 25/90

(57) ABSTRACT

In aspects of audio manipulation of emulated content, a media device includes a memory for storing original audio content. The media device also implements an audio manipulation manager that can receive input audio content that emulates the original audio content. The audio manipulation manager also receives metadata associated with the original audio content that includes a content creator voice category associated with the original audio content. The audio manipulation manager can also determine a user voice category from the input audio content, and then transform the input audio content to manipulated audio content by changing the user voice category to the content creator voice category. To change the user voice category to the content creator voice category, the audio manipulation manager changes a user tone and a user pitch to a content creator tone and a content creator pitch.

### BACKGROUND

Devices such as media devices, smart devices, mobile devices (e.g., cellular phones, tablet devices, smartphones), consumer electronics, and the like can be implemented for use in a wide range of environments and for a variety of different applications. Users of media devices often make content that emulates some original content. For example, users sing along to the tunes of original recorded songs when performing karaoke. However, karaoke equipment is often cumbersome and requires many different components. For example, karaoke may require instruments, large speakers, a computing device, a microphone, a display monitor, etc. Thus, karaoke has made a large shift to take place on various mobile platforms. For example, mobile applications allow for users to record themselves singing along to popular songs, display lyrics to the songs as they are singing, and share the recording for other users to interact or sing along.

### BRIEF DESCRIPTION OF THE DRAWINGS

Implementations of the techniques for audio manipulation of emulated content are described with reference to the following Figures. The same numbers may be used throughout to reference like features and components shown in the Figures.

FIG. 1 illustrates an example system for audio manipulation of emulated content in accordance with one or more implementations as described herein.

FIG. 2 illustrates an example device and features for audio manipulation of emulated content in accordance with one or more implementations as described herein.

FIG. 3 illustrates an example system of audio manipulation of emulated content in accordance with one or more implementations as described herein.

FIG. 4 illustrates an example method for audio manipulation of emulated content in accordance with one or more implementations of the techniques described herein.

FIG. 5 illustrates various components of an example device that may be used to implement the techniques for audio manipulation of emulated content as described herein.

### DETAILED DESCRIPTION

Implementations of the techniques for audio manipulation of emulated content may be implemented as described herein. A media device, such as any type of a wireless device, mobile device, mobile phone, flip phone, client device, tablet, computing, communication, entertainment, gaming, media playback, and/or any other type of computing and/or electronic device, or a system of any combination of such devices, may be configured to perform techniques for audio manipulation of emulated content as described herein. In one or more implementations, a media device includes an audio manipulation manager, which can be used to implement aspects of the techniques described herein.

Conventional mobile platforms and applications have made it more accessible for users to perform karaoke by reducing the number of necessary equipment components down to a single mobile device. These mobile platforms and applications allow users to record themselves singing along to popular songs, display lyrics to the songs as they are singing, and share the recording for other users to interact or sing along. Karaoke performers often wish to emulate the singing style of the original singer. However, a user is limited by his or her voice type. A user can try to change the pitch and tone of their voice to match the original singer, but without proper experience, often fails to emulate the original singer. Alternatively, or in addition, a user can perform a song that was originally performed by more than one singer, requiring the user to remember how each of the original singers performed the song. This can lead to a poor user experience and reduce user satisfaction with the platform or karaoke system. Thus, a solution for mismatching voices during content emulation scenarios is described in aspects of the techniques for audio manipulation of emulated content.

To overcome the difficulties, and in aspects of the described techniques, an audio manipulation manager is implemented by a media device to transform input audio content to manipulated audio content by making a user's voice sound like the creator of some original audio content. The audio manipulation manager can receive input audio content, which may be a user performing a cover of an original song. A cover version of a song is a generally a version of the song recorded by a singer or band who did not originally perform the song. The audio manipulation manager can also receive original audio content, which is the content that the input audio content emulates, such as the original song that the user is covering. The audio manipulation manager can then transform the input audio content into manipulated audio content. This transformation may take place by the audio manipulation manager leveraging a voice modulation algorithm. The manipulated audio content may be a version of the input audio content where the user's voice is changed to sound like the creator of the original audio content. For example, a karaoke user can sing a cover of an original song, and the audio manipulation manager can transform the user's voice to sound like the singer in the original song. In this manner, the audio manipulation manager solves the above-noted difficulties of conventional systems by automatically transforming a user's voice to sound like the singer of the song the user is covering to alleviate a user's anxiety of performing.

In implementations of audio manipulations of emulated content, the audio manipulation manager can receive metadata associated with the original audio content that includes a content creator voice category. The content creator voice category can include a variety of metrics that describe or represent the voice of the creator of the original audio content. For example, a content creator voice category for an original song may include a content creator tone, a content creator pitch, and content creator lyrics. The content creator pitch can describe a vocal timbre of the creator of the original song that the user is covering and/or whether the voice of the creator is a male or a female voice. The content creator pitch can describe a frequency of the voice of the creator of the original song that the user is covering. The content creator lyrics are the words that the creator of the original song says, performs, and/or sings. The content creator voice category can be previously determined by the audio manipulation manager and stored as data, and/or it can be received by the audio manipulation manager from a device application of the media device.

Similarly, the audio manipulation manager can determine a user voice category from the input audio content. The audio manipulation manager may utilize the voice modulation algorithm to determine the user voice category. The user voice category can describe or represent the user's voice in the input audio content in various ways. For example, the user voice category can include a user tone, a user pitch, and user lyrics. The user pitch can describe a vocal timbre of the user performing the input audio content and/or whether the user's voice is a male or a female voice. The user pitch can describe a frequency of the voice of the user performing the input audio content. The user lyrics are the words that the user performing the input audio content says, performs, and/or sings. The user category can be previously determined by the audio manipulation manager from a previous instance of utilizing the audio manipulation manager and stored as data, and/or it can be determined approximately in real time as the input audio content is received.

In implementations of audio manipulation of emulated content, as described herein, the transformation from the input audio content to the manipulated audio content may include changing or merging the user voice category to the content creator voice category. The audio manipulation manager can leverage the voice modulation algorithm to change the user voice category associated with the input audio content from the user to the content creator voice category associated with the original audio content. For example, the voice modulation algorithm may transform the input audio content by changing or merging the user tone to the content creator tone, changing or merging the user pitch to the content creator pitch, and keeping the user lyrics the same. In this manner, the audio manipulation manager can make a karaoke user sound like the singer of the song that the karaoke user is covering.

In implementations of audio manipulation of emulated content, as described herein, the audio manipulation manager can automatically identify the original audio content that is emulated by the input audio content. The audio manipulation manager can detect a tune of the original audio content the user is emulating. For example, if a karaoke user is covering an original song, the audio manipulation manager can detect a tune that is playing for the karaoke user to cover the original song. Alternatively, or in addition, the audio manipulation manager can detect a tune of the input audio content. For example, the audio manipulation manager can receive a karaoke user's input when they are covering a song and detect a tune associated with the original song from the input. Alternatively, or in addition, the audio manipulation manager can access a device application that is supplying the original audio content to receive content identifying information. For example, a karaoke user may select an original song that they wish to cover, and the audio manipulation manager can receive information describing the original song from a device application.

In implementations of audio manipulation of emulated content, as described herein, the audio manipulation manager can change the user voice category to multiple content creator voice categories. For example, a karaoke user may wish to cover an original song that is performed by multiple singers. Alternatively, or in addition, the original song that the karaoke user is covering may be performed by one singer, but the singer performs the original song with different voice types. In these example scenarios, the audio manipulation manager can associate multiple content creator voice categories with the original audio content. For example, multiple content creator voice categories can be associated with different stanzas of an original song. The audio manipulation manager can automatically switch from a user voice category to a first content creator voice category, then to the second content creator voice category, and so on. In this manner, the audio manipulation manager solves the above-noted difficulties with conventional systems by removing the requirement for users to remember how multiple artists perform a song.

Similarly, the audio manipulation manager can receive and/or determine multiple user voice categories that are associated with the input audio content. For example, multiple karaoke users may wish to perform a duet cover of an original song. In this example scenario, the audio manipulation manager can receive input audio content and automatically detect when the input audio content has changed from a first user voice category to a second voice category, and so on. The audio manipulation manager may continuously monitor the input audio content to determine a switch from a first user voice category to a second voice category approximately in real time as the input audio content is received. When the audio manipulation manager determines the switch, the audio manipulation manager can transform the input audio content in order to maintain the appropriate content creator voice category of the manipulated audio content.

In implementations of audio manipulation of emulated content, as described herein, the audio manipulation manager can detect when the media device is operating in an audio manipulation mode. The audio manipulation mode may signal the media device to implement the audio manipulation manager to transform the input audio content to the manipulated audio content. The audio manipulation manager can detect the audio manipulation mode by detecting that a device application, such as an audio application, is running in the foreground of the device. Additionally, the audio manipulation manager can detect that the media device is connected to an audio output device, and/or can detect that the device application, such as the audio application, is requesting the use of a microphone for the input audio content.

Alternatively, or in addition, the audio manipulation manager can receive user input via a user interface of the media device to indicate that the user is placing the media device in the audio manipulation mode and/or intends to apply the voice modulation algorithm to transform the input audio content to the manipulated audio content. For example, a karaoke user may wish to perform karaoke and selects a device application that assists in the process to run in the foreground of their media device by playing the song that the karaoke user wishes to cover. The device application may request use of a microphone to receive the input audio content, such as the karaoke user's performance. The media device may also be connected to an audio output device to output the manipulated content approximately in real time as the input audio content is received. The audio manipulation manager can detect any combination of these processes and prompt the karaoke user to indicate, via user input, whether or not they wish to apply voice modulation to make the karaoke user sound like the singer of the original audio content.

While features and concepts of the described techniques for audio manipulation of emulated content is implemented in any number of different devices, systems, environments, and/or configurations, implementations of the techniques for audio manipulation of emulated content are described in the context of the following example devices, systems, and methods.

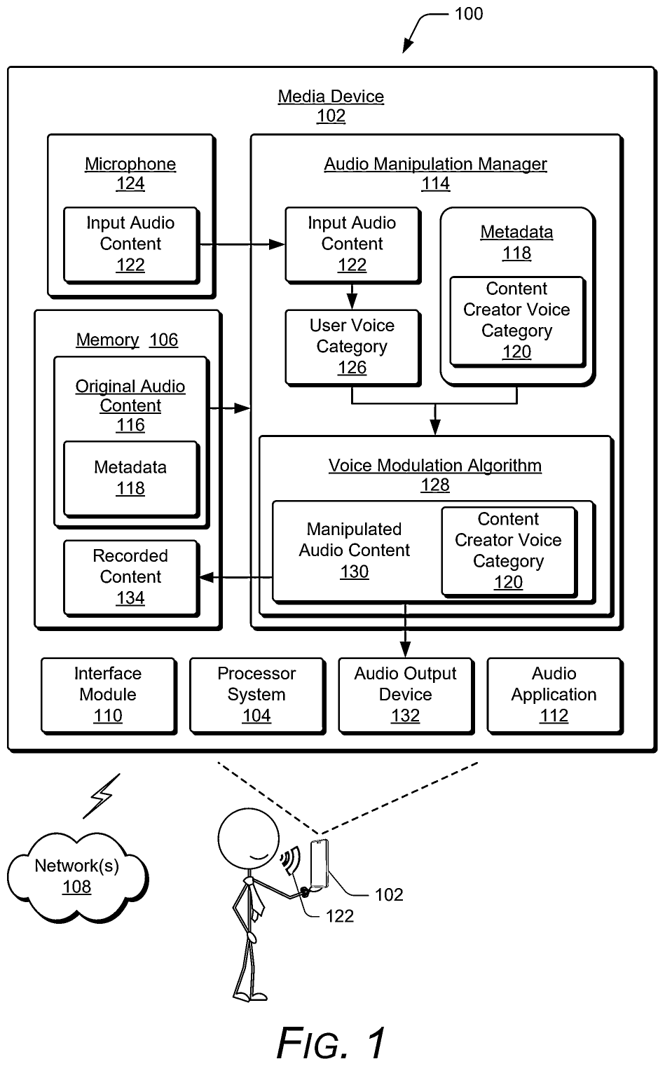

FIG. 1 illustrates an example system 100 for audio manipulation of emulated content, as described herein. The system 100 includes a media device 102. Examples of the media device 102 include any type of a wireless device, mobile device, mobile phone, flip phone, client device, companion device, tablet, computing device, communication device, entertainment device, gaming device, media playback device, and/or any other type of computing, consumer, and/or electronic device.

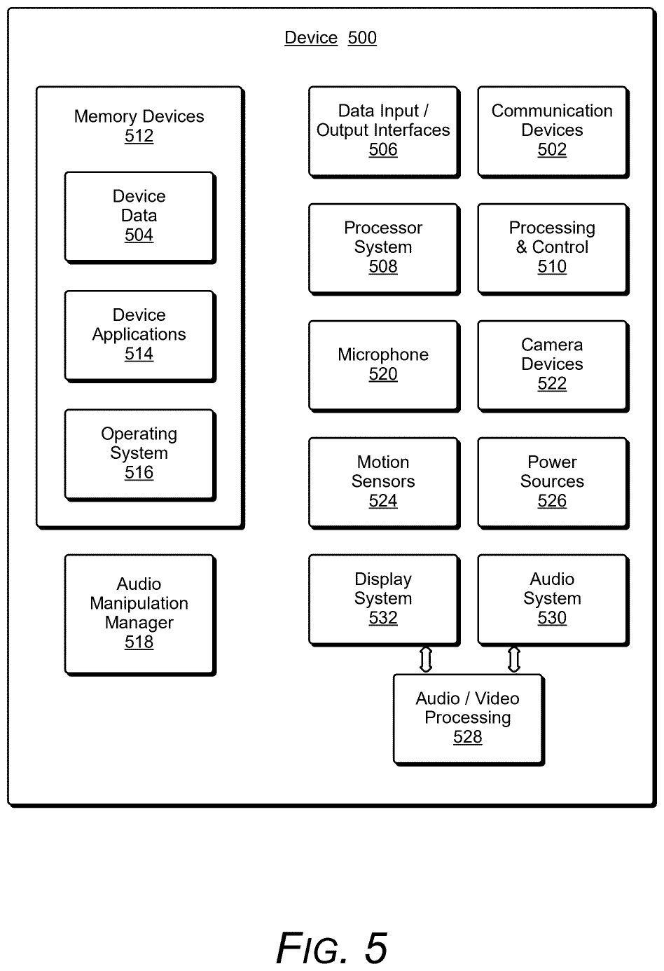

The media device 102 can implemented with various components, such as a processor system 104 and memory 106, as well as any number and combination of different components as further described with reference to the example device shown in FIG. 5. In implementations, the media device 102 includes various radios for wireless communication with other devices. For example, the media device 102 can include at least one of a BLUETOOTH® (BT) or BLUETOOTH® Low Energy (BLE) transceiver, a near field communication (NFC) transceiver, or the like. In some cases, the media device 102 includes at least one of a WI-FI® radio, a cellular radio, a global positioning satellite (GPS) radio, or any available type of device communication interface.

In some implementations, the devices, applications, modules, servers, and/or services described herein communicate via a communication network 108, such as for data communication with the media device 102. The communication network 108 includes a wired and/or a wireless network. The communication network 108 can be implemented using any type of network topology and/or communication protocol, and is represented or otherwise implemented as a combination of two or more networks, to include IP-based networks, cellular networks, and/or the Internet. The communication network 108 can include mobile operator networks that are managed by a mobile network operator and/or other network operators, such as a communication service provider, mobile phone provider, and/or Internet service provider.

The media device 102 includes various functionality that enables the device to implement different aspects of audio manipulation of emulated content, as described herein. In one or more examples, an interface module 110 represents functionality (e.g., logic and/or hardware) enabling the media device 102 to interconnect and interface with other devices and/or networks, such as the communication network 108. For example, the interface module 110 enables wireless and/or wired connectivity of the media device 102.

The media device 102 can include and implement various device applications, such as audio application 112, or any other type of music application, messaging application, email application, video communication application, cellular communication application, gaming application, media application, social platform applications, and/or any other of the many possible types of various device applications. Many of the device applications have an associated application user interface that is generated and displayed for user interaction and viewing, such as on a display screen of the media device 102. Generally, an application user interface, or any other type of video, image, graphic, and the like is digital image content that is displayable on the display screen of the media device 102.

In the example system 100 for audio manipulation of emulated content, the media device 102 implements an audio manipulation manager 114 (e.g., as a device application). As shown in this example, the audio manipulation manager 114 represents functionality (e.g., logic, software, and/or hardware) enabling aspects of the described techniques for audio manipulation of emulated content. The audio manipulation manager 114 can be implemented as computer instructions stored on computer-readable storage media and can be executed by the processor system 104 of the media device 102. Alternatively, or in addition, the audio manipulation manager 114 can be implemented at least partially in hardware of the device.

In one or more implementations, the audio manipulation manager 114 includes independent processing, memory, and/or logic components functioning as a computing and/or electronic device integrated with the media device 102. Alternatively, or in addition, the audio manipulation manager 114 can be implemented in software, in hardware, or as a combination of software and hardware components. In this example system 100, the audio manipulation manager 114 is implemented as a software application or module, such as executable software instructions (e.g., computer-executable instructions) that are executable with the processor system 104 of the media device 102 to implement the techniques and features described herein. As a software application or module, the audio manipulation manager 114 can be stored on computer-readable storage memory (e.g., memory of a device), or in any other suitable memory device or electronic data storage implemented with the manager. Alternatively, or in addition, the audio manipulation manager 114 is implemented in firmware and/or at least partially in computer hardware. For example, at least part of the audio manipulation manager 114 is executable by a computer processor, such as the processor system 104, and/or at least part of the audio manipulation manager is implemented in logic circuitry.

In this example system 100, the audio manipulation manager 114 receives original audio content 116. As used herein the term “original audio content” includes any type of data including audio data that is associated with an audio file, song, video clip, digital video, live video stream, and/or any other type of digital content. For example, the original audio content 116 can be a song composed by a content creator and is stored on the memory 106. Alternatively, or in addition, the original audio content 116 can be audio data associated with a digital video, for example, from a social network platform.

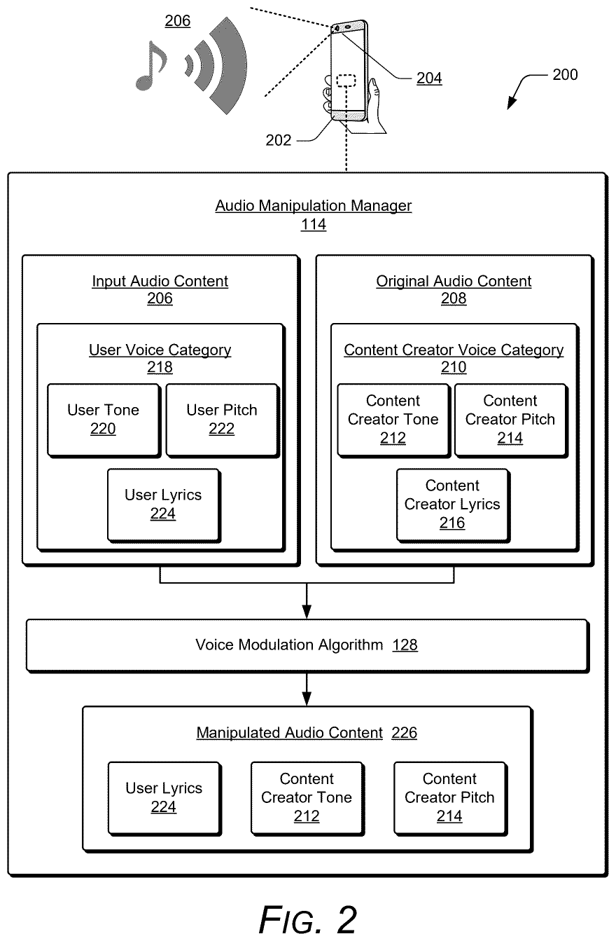

Additionally, the audio manipulation manager 114 receives metadata 118 that describes the original audio content 116. The metadata 118 can describe the original audio content 116 in various ways. In this example system 100, the metadata 118 describes or represents the original audio content 116 with a content creator voice category 120. The content creator voice category 120 may include any number of metrics describing the original audio content 116, as further described with reference to the example system shown in FIG. 2. For example, the content creator voice category 120 may include metrics that describe the original audio content 116 such as a content creator tone, a content creator pitch, and content creator lyrics.

In this example system 100, the audio manipulation manager 114 receives the original audio content 116 from the memory 106. Alternatively, or in addition, the audio manipulation manager 114 may receive the original audio content 116 including the metadata 118 and the content creator voice category 120 from any number of sources. For example, the audio manipulation manager 114 may receive the original audio content 116 including the metadata 118 and the content creator voice category 120 from various device applications such as the audio application 112 or communicated over the communication network 108 via a wireless radio, such as from devices other than the media device 102.

In implementations of audio manipulation of emulated content, the audio manipulation manager 114 can receive input audio content 122. As used herein the term “input audio content” includes any type of data including audio data that is associated with an audio file, song, video clip, digital video, live video stream, and/or any other type of digital content. In implementations, the input audio content 122 emulates the original audio content 116. For example, a user of the media device 102 can perform the input audio content 122 as a cover of a song that is composed by a content creator and stored on the memory 106.

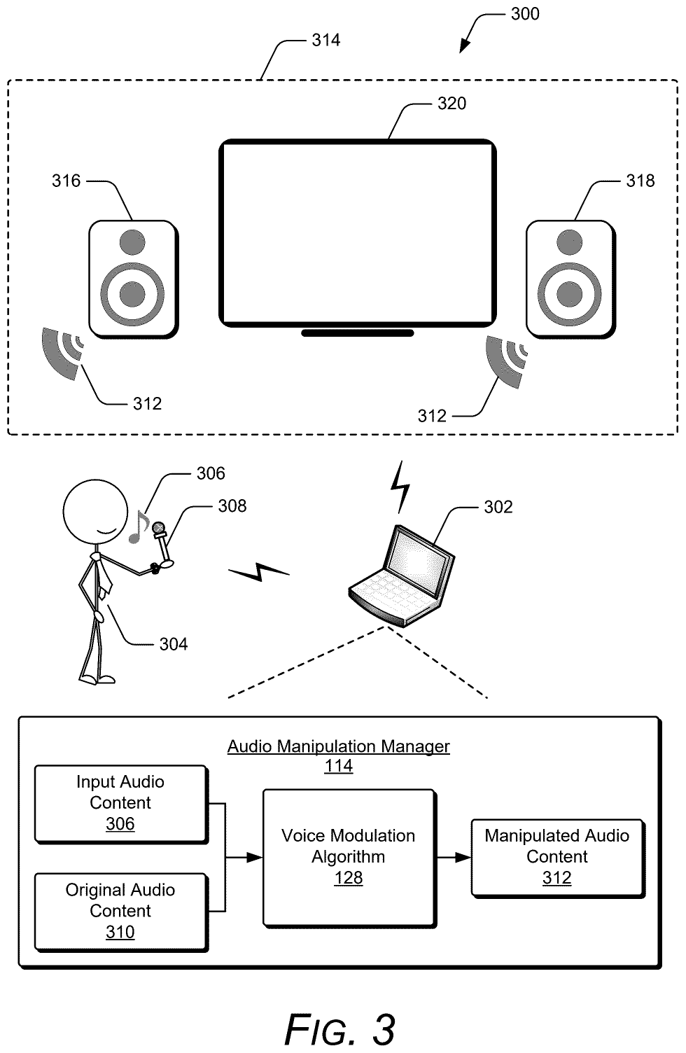

Additionally, the input audio content 122 can be received from a microphone 124 that is either implemented as a component of the media device 102, or may be external to the media device 102, as further described with reference to the example system shown in FIG. 3. Alternatively, or in addition, the audio manipulation manager 114 can receive the input audio content 122 from any number of sources. For example, the audio manipulation manager 114 may receive the input audio content 122 from various device applications, such as the audio application 112, from the memory 106 as stored input audio content, or communicated over the communication network 108, such as from devices other than the media device 102. The audio manipulation manager 114 can also receive the input audio content 122 as associated with a video that a user of the media device 102 has recorded, or is currently recording.

In this example system 100, the audio manipulation manager 114 determines a user voice category 126 from the input audio content 122. In implementations, the user voice category 126 may be determined approximately in real time as the audio manipulation manager 114 receives the input audio content 122. The user voice category 126 may also be predetermined, such as from a previous instance when a user of the media device 102 utilized the audio manipulation manager 114. Similar to the content creator voice category 120, the user voice category 126 may include any number of metrics describing or representing the input audio content 122, as further described with reference to the example system shown in FIG. 2. For example, the user voice category 126 may include metrics that describe the input audio content 122, such as a user tone, a user pitch, and user lyrics. In implementations, the audio manipulation manager 114 may utilize a voice modulation algorithm 128 to determine the user voice category 126.

Similarly, the content creator voice category 120 may be previously determined by the audio manipulation manager 114, such as by utilizing the voice modulation algorithm 128 and storing the original audio content 116 with the associated content creator voice category on the memory 106. The audio manipulation manager 114 may utilize the voice modulation algorithm 128 to associate one or more content creator voice categories (e.g., the content creator voice category 120) to sections of the original audio content 116. For example, the audio manipulation manager 114 can associate one or more singers to the stanzas of a song (e.g., the original audio content 116). This can be determined by the voice modulation algorithm 128 and/or received in the metadata 118, for example, from a device application such as the audio application 112. The voice modulation algorithm 128 can determine one or more content creator voice categories, such as the content creator voice category 120, to associate with the one or more singers that are associated with the stanzas of the song (e.g., the original audio content 116).

In implementations of audio manipulation of emulated content, the audio manipulation manager 114 further utilizes the voice modulation algorithm 128 to transform or merge the input audio content 122 into manipulated audio content 130. The audio manipulation manager 114 transforms or merges the input audio content 122 into the manipulated audio content 130 by changing the user voice category 126 of the input audio content 122 to match the content creator voice category 120 of the original audio content 116. For example, a user of the media device 102 may perform a cover song, such as the input audio content 122 that emulates the original audio content 116. Approximately in real time as the user is performing the cover song, the audio manipulation manager 114 can transform the input audio content 122 to the manipulated audio content 130. The manipulated audio content 130 is then a version of the cover song performed by the user of the media device 102 that is transformed to make the user of the media device sound like (or approximately sound like) the content creator of the song that the user is covering. This process is carried out by the audio manipulation manager 114 utilizing the voice modulation algorithm 128 to change the user voice category 126 to the content creator voice category 120.

The audio manipulation manager 114 can additionally output the manipulated audio content 130. For example, the audio manipulation manager 114 can communicate the manipulated audio content 130 to an audio output device 132 for output. In implementations, the audio output device 132 may be external to the media device 102, as further described with reference to the example system in FIG. 3. In this example system 100, the audio output device 132, such as a device speaker, is implemented on the media device 102. Alternatively, or in addition, the audio manipulation manager 114 can communicate the manipulated audio content 130 to the memory 106 for storage as recorded content 134. Alternatively, or in addition, the recorded content 134 and/or the manipulated audio content 130 may be communicated to various device applications, such as the audio application 112, for sharing on a social network platform.

In implementations of audio manipulation of emulated content, as described herein, the audio manipulation manager 114 can be implemented in a karaoke setting. For example, the original audio content 116 can be a song composed by one or more content creators, and the input audio content 122 can be a cover of the song, which is performed by a user of the media device 102 to emulate the original audio content. The audio manipulation manager 114 can manipulate the input audio content 122 to make the voice of a user of the media device 102 sound like the voice(s) of the one or more content creators of the original audio content 116. In a karaoke setting, the audio manipulation manager 114 can transform or merge the input audio content 122 into the manipulated audio content 130 approximately in real time as the audio manipulation manager receives the input audio content. For example, the audio manipulation manager 114 utilizes the voice modulation algorithm 128 to transform or merge the input audio content 122 to the manipulated audio content 130 with the content creator voice category 120 approximately in real time as the input audio content is received.

In implementations of audio manipulation of emulated content, as described herein, multiple content creators can be associated with the original audio content 116, and the audio manipulation manager 114 can receive multiple content creator voice categories describing the voices of the multiple content creators of the original audio content, such as the content creator voice category 120. The audio manipulation manager 114 can continuously monitor the input audio content 122 and the original audio content 116 to determine when to change the from a first content creator voice category to a second content creator voice category. For example, the audio manipulation manager 114 can receive the input audio content 122 and the original audio content 116 that includes a first content creator voice category, such as the content creator voice category 120, and a second content creator voice category. The audio manipulation manager 114 can implement the voice modulation algorithm 128 to transform or merge the input audio content 122 to the manipulated audio content 130 by changing the user voice category 126 to a first content creator voice category, such as the content creator voice category 120. Approximately simultaneous to the transformation into the manipulated audio content 130, the audio manipulation manager 114 can detect when the original audio content 116 switches from a first content creator voice category, such as the content creator voice category 120, to a second content creator voice category. Upon this detection, the audio manipulation manager 114 can further transform the manipulated audio content 130 by changing from the first content creator voice category to the second content creator voice category. The audio manipulation manager 114 can perform this process with any number of content creator voice categories associated with the original audio content 116.

For example, the audio manipulation manager 114 can associate multiple singers to the stanzas of a song (e.g., the original audio content 116). The audio manipulation manager 114 can further associate different content creator voice categories (e.g., the content creator voice category 120) with the multiple singers that are associated with the stanzas of the song (e.g., the original audio content 116). As a user of the media device 102 is creating audio (e.g., the input audio content 122) that emulates the song (e.g., the original audio content 116), the audio manipulation manager 114 will transform the voice of the user to match (or approximately match) the first of the multiple content creator voice categories (e.g., the content creator voice category 120). When the user of the media device 102 gets to a part of the song where a different content creator voice category is associated, the audio manipulation manager 114 can then automatically switch from the first content creator voice category (e.g., the content creator voice category 120) to a second content creator voice category, and so forth. This process may be performed with any number of content creator voice categories. Alternatively, or in addition, this process may be carried out with a single singer associated with the song (e.g., the original audio content 116), and multiple content creator voice categories (e.g., the content creator voice category 120) that are associated with the single singer.

In implementations of audio manipulation of emulated content, as described herein, the audio manipulation manager 114 can detect when the media device 102 is operating in an audio manipulation mode. The audio manipulation mode may signal the media device 102 to implement the audio manipulation manager 114 to transform or merge the input audio content 122 into the manipulated audio content 130. The audio manipulation manager 114 can detect the audio manipulation mode by detecting that a device application, such as the audio application 112, is running in the foreground of the media device 102. Alternatively, or in addition, the audio manipulation manager 114 can detect that the media device 102 is connected to an audio output device, such as the audio output device 132. Alternatively, or in addition, the audio manipulation manager 114 can detect that the device application that is running in the foreground of the media device 102, such as the audio application 112, is requesting use of a microphone, such as the microphone 124. Alternatively, or in addition, the audio manipulation manager 114 can receive user input, for example via a user interface of the media device 102, to indicate that the user is placing the media device in the audio manipulation mode and/or intends to apply the voice modulation algorithm 128 to transform the input audio content 122 to the manipulated audio content 130.

In implementations of audio manipulation of emulated content, as described herein, the audio manipulation manager 114 can automatically identify the original audio content 116 that is emulated by the input audio content 122. As described above, the audio manipulation manager 114 can detect when the media device 102 is operating in the audio manipulation mode. While operating the media device 102 in the audio manipulation mode, a user can utilize a device application, such as the audio application 112, to play the original audio content 116 as the user is providing the input audio content 122 to emulate the original audio content. To identify the original audio content 116, the audio manipulation manager 114 can access the device application, such as the audio application 112, and identify the original audio content playing from the device application by receiving or determining content identifying information from the device application. Alternatively, or in addition, the audio manipulation manager 114 can detect a tune of the original audio content 116 that is playing from the device application, such as the audio application 112, and the audio manipulation manager 114 can identify the original audio content 116 by detecting a tune of the input audio content 122.

FIG. 2 illustrates an example 200 of a media device 202 that can be used to implement the techniques of audio manipulation of emulated content, as described herein, such as the media device 102 that is shown and described with reference to FIG. 1. In this example 200, the media device 202 may be any type of a wireless device, mobile device, mobile phone, flip phone, client device, companion device, tablet, computing device, communication device, entertainment device, gaming device, media playback device, and/or any other type of computing, consumer, and/or electronic device. Generally, the media device 202 may be any type of an electronic and/or computing device implemented with various components, such as a processor system and memory, as well as any number and combination of different components as further described with reference to the example device shown in FIG. 5.

In this example 200, the media device 202 has a microphone 204. Generally, the microphone 204 is configured to capture any type of input audio content 206. For example, the input audio content 206 that is captured by the microphone 204 can be a song performed by a user of the media device 202 that emulates some original audio content 208. As described above with reference to FIG. 1, the terms “input audio content” and “original audio content” include any type of data including audio data that is associated with an audio file, song, video clip, digital video, live video stream, and/or any other type of digital content. The microphone 204 can be implemented on the media device 202, as shown in FIG. 2, or it can be external to the media device 202, as further described with reference to the example system shown in FIG. 3.

In this example 200, the media device 202 includes the audio manipulation manager 114 that implements features of audio manipulation of emulated content, as described herein and generally as shown and described with reference to FIG. 1. The audio manipulation manager 114 can receive the original audio content 208 from any number of sources. For example, the audio manipulation manager 114 may receive the original audio content 208 from various device applications on the media device 202, such as an audio application, a cloud storage application, and/or any other device application. Alternatively, or in addition, the audio manipulation manager 114 may receive the original audio content 208 from a memory that is implemented on the media device 202, or may receive the original audio content 208 from another device via a wireless radio over a communication network.

In implementations of audio manipulation of emulated content, as described herein, the audio manipulation manager 114 can automatically identify the original audio content 208 that the input audio content 206 emulates. For example, a user of the media device 202 may be performing the input audio content 206, such as a song that emulates an original song (e.g., the original audio content 208). If the media device 202 is using the audio manipulation manager 114 to transform or merge the input audio content 206 into the manipulated audio content 226, the user may be playing the original audio content 208 while also providing or inputting the input audio content. The original audio content 208 may generated for playback from a device application, such as an audio application. The audio manipulation manager 114 can identify the original audio content 208 playing from the device application by receiving or determining content identifying information from the device application. Alternatively, or in addition, the audio manipulation manager 114 can detect a tune of the original audio content 208 that is playing from the device application, as well as identify the original audio content 208 by detecting a tune of the input audio content 206.

In this example 200, the audio manipulation manager 114 receives a content creator voice category 210 that describes the original audio content 208. The content creator voice category 210 may be received as metadata associated with the original audio content 208. The content creator voice category 210 can describe the voice of the creator of the original audio content 208 in various ways. In this example 200, the content creator voice category 210 includes a content creator tone 212, a content creator pitch 214, and content creator lyrics 216. Alternatively, or in addition, the content creator voice category 210 can include any number of metrics that describe or represent the original audio content 208. The content creator tone 212 can describe the vocal timbre of the voice of the person who created the original audio content 208 and/or whether the voice of the person who created the original audio content is a male voice or a female voice. The content creator pitch 214 can describe the frequency of the voice of the person who created the original audio content 208. The content creator lyrics 216 describe the words that the creator of the original audio content 208 is saying, singing, and/or performing in the original audio content.

Additionally, the content creator voice category 210 that includes the content creator tone 212, the content creator pitch 214, and the content creator lyrics 216 may be previously determined by the audio manipulation manager 114 utilizing the voice modulation algorithm 128, as described herein and generally as shown and described with reference to FIG. 1. For example, the audio manipulation manager 114 can utilize the voice modulation algorithm 128 to associate one or more content creator voice categories (e.g., the content creator voice category 210) to sections of the original audio content 208. The voice modulation algorithm 128 can also be used by the audio manipulation manager 114 to determine one or more content creator tones, content creator pitches, and/or content creator lyrics (e.g., the content creator tone 212, the content creator pitch 214, and/or the content creator lyrics 216) to associate with the one or more content creator voice categories associated with the different sections of the original audio content 208. This information can be stored as metadata in a memory of the media device 202 and accessed later by the media device. Alternatively, or in addition, the audio manipulation manager 114 can receive this information from a device application of the media device 202, such as an audio application.

In implementations of audio manipulation of emulated content, as described herein, the audio manipulation manager 114 can identify a user voice category 218 of the input audio content 206. The user voice category 218 can describe the voice of the user of the media device 202 in various ways as the user provides or inputs the input audio content 206. In this example 200, the user voice category 218 includes a user tone 220, a user pitch 222, and user lyrics 224. Alternatively, or in addition, the user voice category 218 can include any number of metrics that describe or represent the input audio content 206. The user tone 220 can describe the vocal timbre of the voice of the person who performed or is performing the input audio content 206 and/or whether the voice of the person who performed or is performing the input audio content is a male voice or a female voice. The user pitch 222 can describe the frequency of the voice of the person who performed or is performing the input audio content 206. The user lyrics 224 describe the words that the person who performed or is performing the input audio content 206 is saying, singing, and/or performing in the input audio content. The user voice category 218 may be determined approximately in real time as the user of the media device 202 is inputting the input audio content 206 or as the audio manipulation manager 114 receives the input audio content. Alternatively, or in addition, the user voice category 218 can be predetermined, such as from a previous instance when the media device 202 utilized the audio manipulation manager 114 for the user of the media device. In implementations, the audio manipulation manager 114 utilizes the voice modulation algorithm 128 to determine the user voice category 218.

In this example 200, the audio manipulation manager 114 leverages the voice modulation algorithm 128 to transform or merge the input audio content 206 into the manipulated audio content 226. The audio manipulation manager 114 transforms the input audio content 206 to the manipulated audio content 226 by changing the user tone 220 and the user pitch 222 to the content creator tone 212 and the content creator pitch 214 of the original audio content 208. For example, a user of the media device 202 may perform a cover song, such as the input audio content 206 that emulates the original audio content 208. Approximately in real time as the user is performing the cover song, the audio manipulation manager 114 can transform or merge the input audio content 206 into the manipulated audio content 226. The manipulated audio content 226 is a version of the cover song performed by the user of the media device 202 that is transformed to make the user of the media device sound approximately like the content creator of the song that the user is covering. The audio manipulation manager 114 may utilize the voice modulation algorithm 128 to change the user tone 220 and the user pitch 222 to the content creator tone 212 and content creator pitch 214 while keeping the user lyrics 224 the same.

In implementations of audio manipulation of emulated content, as described herein, the audio manipulation manager 114 can be implemented in a karaoke setting. For example, the original audio content 208 can be a song composed by one or more content creators, and the input audio content 206 can be a cover of the song and is performed by a user of the media device 202 to emulate the original audio content. The audio manipulation manager 114 can manipulate the input audio content 206 to make the voice of the user of the media device 202 to sound approximately like the voice(s) of the one or more content creators of the original audio content 208. In a karaoke setting, the audio manipulation manager 114 can transform or merge the input audio content 206 into the manipulated audio content 226 approximately in real time as the audio manipulation manager receives the input audio content. For example, the audio manipulation manager 114 utilizes the voice modulation algorithm 128 to transform the input audio content 206 to the manipulated audio content 226 with the user lyrics 224, the content creator tone 212, and the content creator pitch 214 approximately in real time as the input audio content is received.

In implementations of audio manipulation of emulated content, as described herein, the audio manipulation manager 114 can receive multiple content creator voice categories, such as the content creator voice category 210, associated with the original audio content 208. The multiple content creator voice categories can be associated with multiple content creators of the original audio content 208. Alternatively, or in addition, the multiple content creator voice categories can be associated with a single content creator of the original audio content 208. The audio manipulation manager 114 can continuously monitor the input audio content 206 and the original audio content 208 to determine when to change from a first content creator voice category, such as the content creator voice category 210, to a second content creator voice category. For example, the audio manipulation manager 114 can receive the input audio content 206 and the original audio content 208 that includes a first content creator voice category, such as the content creator voice category 210, and a second content creator voice category. The first content creator voice category can include a first content creator tone and a first content creator pitch that are associated with first content creator lyrics. The second content creator voice category can include a second content creator tone and a second content creator pitch that are associated with second content creator lyrics.

Initially, the audio manipulation manager 114 can utilize the voice modulation algorithm 128 to transform or merge the input audio content 206 into the manipulated audio content 226 by changing the user tone 220 and the user pitch 222 to the first content creator tone and the first content creator pitch while retaining the user lyrics 224. Approximately simultaneous to this first transformation, the audio manipulation manager 114 can detect when the original audio content 208 switches from the first content creator voice category to the second content creator voice category. For example, this can occur when the first content creator lyrics end, and the second content creator lyrics begin. Upon this detection, the audio manipulation manager 114 can further transform the manipulated audio content 226 by changing the first content creator tone and the first content creator pitch to the second content creator tone and the second content creator pitch while retaining the user lyrics 224. The audio manipulation manager 114 can perform this process with any number of content creator voice categories and any number of content creator tones, content creator pitches, and content creator lyrics that are associated with the original audio content 208.

Similarly, the audio manipulation manager 114 can receive and/or determine multiple user voice categories, such as the user voice category 218, associated with the input audio content 206. For example, multiple users of the media device 202 may wish to perform a duet cover of an original song (e.g., the original audio content 208). Alternatively, or in addition, a single user of the media device 202 may change their voice mid-performance such that multiple user voice categories, such as the user voice category 218, are associated with the input audio content 206. In these example scenarios, the audio manipulation manager 114 can automatically detect when the input audio content has changed from a first user voice category, such as the user voice category 218 with the user tone 220, the user pitch 222 and the user lyrics 224, to a second user voice category, and so on. The audio manipulation manager 114 may continuously monitor the input audio content 206 to determine a switch from the first user voice category, such as the user voice category 218, to the second user voice category approximately in real time as the input audio content is received. When the audio manipulation manager 114 determines the switch, the audio manipulation manager can transform or merge the input audio content 206 in order to maintain the appropriate metrics, such as the content creator tone 212, the content creator pitch 214, and the user lyrics 224 of the manipulated audio content 226.

FIG. 3 illustrates an example 300 of a system including a media device 302 that can be used to implement the techniques of audio manipulation of emulated content, as described herein, such as the media device 102 that is shown and described with reference to FIG. 1. In this example 300, the media device 302 may be any type of a wireless device, mobile device, mobile phone, flip phone, client device, companion device, tablet, computing device, communication device, entertainment device, gaming device, media playback device, and/or any other type of computing, consumer, and/or electronic device. Generally, the media device 302 may be any type of an electronic and/or computing device implemented with various components, such as a processor system and memory, as well as any number and combination of different components as further described with reference to the example device shown in FIG. 5.

In this example 300, the media device 302 is implemented in a karaoke setting. For example, a user 304 is singing input audio content 306 into a microphone 308 that emulates original audio content 310. In this example 300, the microphone 308 is external from the media device 302 and communicates the input audio content 306 to the media device 302 over a wireless network, such as the communication network 108 as described in FIG. 1. However, the microphone 308 may be an integrated component and/or internal to the media device 302, such as the microphone 124 of FIG. 1. The microphone 308 can communicate the input audio content 306 to the media device 302.

In this example 300, the media device 302 includes the audio manipulation manager 114 that implements features of audio manipulation of emulated content, as described herein and generally as shown and described with reference to FIGS. 1 and 2. The audio manipulation manager 114 can receive the original audio content 310 that is emulated by the input audio content 306. For example, the user 304 may be performing the input audio content 306 as a song that covers the original audio content 310. The audio manipulation manager 114 can receive the original audio content 310 from any number of sources, as described above in further detail in relation to FIGS. 1 and 2. Additionally, the original audio content 310 can be automatically identified by the audio manipulation manager 114, as described above in further detail in relation to FIGS. 1 and 2.

In implementations of audio manipulation of emulated content, as described herein, the audio manipulation manager 114 can transform or merge the input audio content 306 into manipulated audio content 312. The audio manipulation manager 114 can use the voice modulation algorithm 128 to transform or merge the input audio content 306 into the manipulated audio content 312, as described above in further detail in relation to FIGS. 1 and 2. For example, the audio manipulation manager 114 can receive the input audio content 306 performed by the user 304 into the microphone 308 and receive the original audio content 310 from any number of sources. The audio manipulation manager 114 implements the voice modulation algorithm 128 to transform or merge the input audio content 306 into the manipulated audio content 312.

In this example 300, the media device 302 communicates the manipulated audio content 312 to an external output configuration 314. The external output configuration 314 includes external audio output devices 316, 318 and the external monitor 320. The external audio output devices 316, 318 can receive the manipulated audio content 312 for output, such as an audio output. The external monitor 320 can receive data associated with the original audio content 310 for display. For example, the external monitor 320 can receive lyrics associated with the original audio content 310, such as the content creator lyrics 216 that is shown and described with reference to FIG. 2.

In implementations of audio manipulation of emulated content, the audio manipulation manager 114 can be implemented in a karaoke setting. For example, the user 304 can select a song, such as the original audio content 310, to emulate with the input audio content 306. Lyrics of the original audio content 310 can be communicated from the media device 302 to the external output configuration 314 for display on the external monitor 320. The user 304 can perform a cover of the original audio content 310 that is communicated as the input audio content 306 from the microphone 308 to the audio manipulation manager 114 that is implemented by the media device 302. The audio manipulation manager 114 can transform or merge the input audio content 306 into the manipulated audio content 312 to make the voice of the user 304 sound approximately like the creator of the original audio content 310. This transformation can take place approximately in real time as the input audio content 306 is received. Thus, the audio manipulation manager 114 can output the manipulated audio content 312 via the external audio output devices 316, 318 approximately at the same time the user 304 is performing the input audio content 306.

In implementations of audio manipulation of emulated content, the audio manipulation manager 114 can receive the input audio content 306 as performed by multiple users, such as the user 304 and/or additional users. For example, multiple users, such as the user 304, can perform the input audio content 306 successively as a duet, and the audio manipulation manager 114 can transform or merge the input audio content into the manipulated audio content 312 for output to the external output configuration 314. The audio manipulation manager 114 can receive the input audio content 306 and determine multiple user voice categories, such as the user voice category 218 that is shown and described with reference to FIG. 2. The multiple user voice categories are changed to one or more content creator voice categories, such as the content creator voice category 210 that is shown and described with reference to FIG. 2. The audio manipulation manager 114 can also change the input audio content 306 to make the user 304 sound like multiple content creators of the original audio content 310, as described above in further detail in relation to FIGS. 1 and 2. For example, multiple artists and content creator voice categories can be associated with the song that the user 304 is emulating with the input audio content 306. The audio manipulation manager 114 can change the input audio content 306 to make the user 304 sound like multiple artists of the original audio content 310.

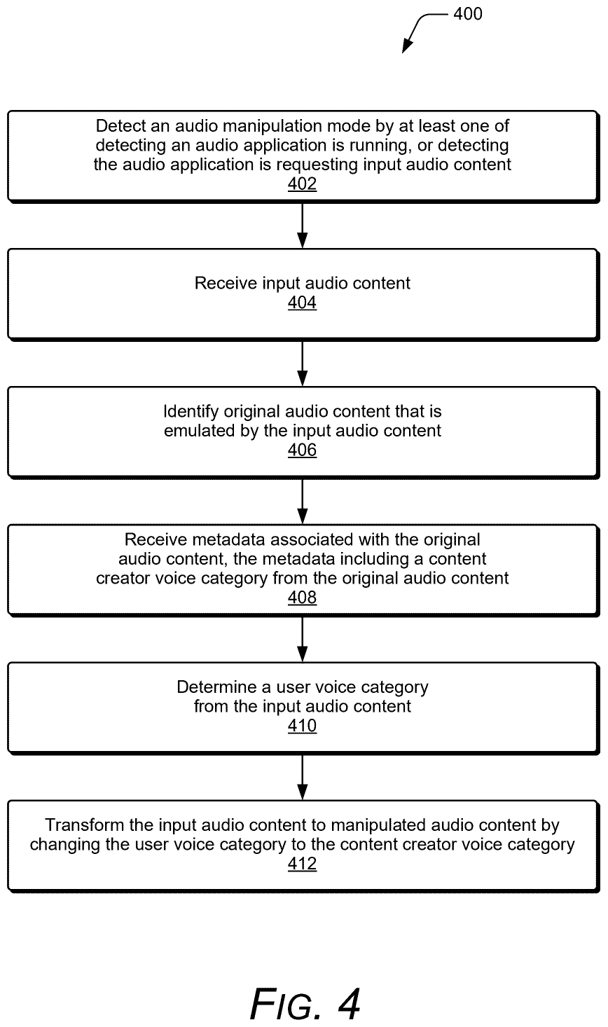

Example method 400 is described with reference to FIG. 4 in accordance with one or more implementations of audio manipulation of emulated content, as described herein. Generally, any services, components, modules, managers, controllers, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively, or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 4 illustrates example method(s) 400 for audio manipulation of emulated content. The order in which the method is described is not intended to be construed as a limitation, and any number or combination of the described method operations may be performed in any order to perform a method, or an alternate method.

At 402, an audio manipulation mode is detected by detecting an audio application is running, or by detecting the audio application is requesting input audio content. For example, the audio manipulation manager 114 detects the audio manipulation mode by detecting an audio application 112 is running, or by detecting the audio application is requesting input audio content 122. The audio manipulation mode may signal the media device 102 to implement the audio manipulation manager 114 to transform or merge the input audio content 122 into the manipulated audio content 130.

At 404, input audio content is received. For example, the audio manipulation manager 114 receives the input audio content 122. The input audio content 122 can include any type of data including audio data that is associated with an audio file, song, video clip, digital video, live video stream, and/or any other type of digital content.

At 406, original audio content that is emulated by the input audio content is identified. For example, the audio manipulation manager 114 identifies the original audio content 116 that is emulated by the input audio content 122. In implementations, the original audio content 116 can be a song, and the input audio content 122 can be a cover of the song. The audio manipulation manager 114 can identify the original audio content 116 by accessing the audio application 112 to determine the original audio content and/or by detecting a tune of the input audio content 122. The original audio content 116 can include any type of data including audio data that is associated with an audio file, song, video clip, digital video, live video stream, and/or any other type of digital content.

At 408, metadata associated with the original audio content is received, the metadata including a content creator voice category from the original audio content. For example, the audio manipulation manager 114 receives the metadata 118 that includes the content creator voice category 120 associated with the original audio content 116. Additionally, a second content creator voice category can be included with the metadata 118 associated with the original audio content 116. The content creator voice category 120 may include metrics describing and/or representing the original audio content 116, such as the content creator tone 212, the content creator pitch 214, and the content creator lyrics 216.

At 410, a user voice category is determined from the input audio content. For example, the audio manipulation manager 114 determines the user voice category 126 from the input audio content 122. The user voice category 126 may be determined approximately in real time as the audio manipulation manager 114 receives the input audio content 122. The user voice category 126 can include metrics describing or representing the input audio content 122, such as the user tone 220, the user pitch 222, and the user lyrics 224.

At 412, the input audio content is transformed to manipulated audio content by changing the user voice category to the content creator voice category. For example, the audio manipulation manager 114 transforms or merges the input audio content 122 into the manipulated audio content 130 by changing the user voice category 126 to the content creator voice category 120. In implementations, the audio manipulation manager 114 changes the user voice category 126 to the content creator voice category 120 by changing the user tone 220 and the user pitch 222 to the content creator tone 212 and the content creator pitch 214. The manipulated audio content 130 can be further transformed by changing the content creator voice category 120 to a second content creator voice category.

FIG. 5 illustrates various components of an example device 500, which can implement aspects of the techniques and features for audio manipulation of emulated content, as described herein. The example device 500 may be implemented as any of the devices described with reference to the previous FIGS. 1-4, such as any type of a wireless device, mobile device, mobile phone, flip phone, client device, companion device, display device, tablet, computing, communication, entertainment, gaming, media playback, and/or any other type of computing, consumer, and/or electronic device. For example, the media device 102 described with reference to FIG. 1 may be implemented as the example device 500.

The example device 500 can include various, different communication devices 502 that enable wired and/or wireless communication of device data 504 with other devices. The device data 504 can include any of the various devices' data and content that is generated, processed, determined, received, stored, and/or communicated from one computing device to another. Generally, the device data 504 can include any form of audio, video, image, graphics, and/or electronic data that is generated by applications executing on a device. The communication devices 502 can also include transceivers for cellular phone communication and/or for any type of network data communication.

The example device 500 can also include various, different types of data input/output (I/O) interfaces 506, such as data network interfaces that provide connection and/or communication links between the devices, data networks, and other devices. The I/O interfaces 506 may be used to couple the device to any type of components, peripherals, and/or accessory devices, such as a computer input device that may be integrated with the example device 500. The I/O interfaces 506 may also include data input ports via which any type of data, information, media content, communications, messages, and/or inputs may be received, such as user inputs to the device, as well as any type of audio, video, image, graphics, and/or electronic data received from any content and/or data source.

The example device 500 includes a processor system 508 of one or more processors (e.g., any of microprocessors, controllers, and the like) and/or a processor and memory system implemented as a system-on-chip (SoC) that processes computer-executable instructions. The processor system 508 may be implemented at least partially in computer hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively, or in addition, the device may be implemented with any one or combination of software, hardware, firmware, or fixed logic circuitry that may be implemented in connection with processing and control circuits, which are generally identified at 510. The example device 500 may also include any type of a system bus or other data and command transfer system that couples the various components within the device. A system bus can include any one or combination of different bus structures and architectures, as well as control and data lines.

The example device 500 also includes memory and/or memory devices 512 (e.g., computer-readable storage memory) that enable data storage, such as data storage devices implemented in hardware which may be accessed by a computing device, and that provide persistent storage of data and executable instructions (e.g., software applications, programs, functions, and the like). Examples of the memory devices 512 include volatile memory and non-volatile memory, fixed and removable media devices, and any suitable memory device or electronic data storage that maintains data for computing device access. The memory devices 512 can include various implementations of random-access memory (RAM), read-only memory (ROM), flash memory, and other types of storage media in various memory device configurations. The example device 500 may also include a mass storage media device.

The memory devices 512 (e.g., as computer-readable storage memory) provide data storage mechanisms, such as to store the device data 504, other types of information and/or electronic data, and various device applications 514 (e.g., software applications and/or modules). For example, an operating system 516 may be maintained as software instructions with a memory device 512 and executed by the processor system 508 as a software application. The device applications 514 may also include a device manager, such as any form of a control application, software application, signal-processing and control module, code that is specific to a particular device, a hardware abstraction layer for a particular device, and so on.

In this example, the device 500 includes an audio manipulation manager 518 that implements various aspects of the described features and techniques described herein. The audio manipulation manager 518 may be implemented with hardware components and/or in software as one of the device applications 514, such as when the example device 500 is implemented as the media device 102 described with reference to FIG. 1. An example of the audio manipulation manager 518 is the audio manipulation manager 114 implemented by the media device 102, such as a software application and/or as hardware components in the media device. In implementations, the audio manipulation manager 518 may include independent processing, memory, and logic components as a computing and/or electronic device integrated with the example device 500.

The example device 500 can also include a microphone 520 (e.g., to capture an audio recording of a user) and/or camera devices 522 (e.g., to capture video images of the user during a call), as well as motion sensors 524, such as may be implemented as components of an inertial measurement unit (IMU). The motion sensors 524 may be implemented with various sensors, such as a gyroscope, an accelerometer, and/or other types of motion sensors to sense motion of the device. The motion sensors 524 can generate sensor data vectors having three-dimensional parameters (e.g., rotational vectors in x, y, and z-axis coordinates) indicating location, position, acceleration, rotational speed, and/or orientation of the device. The example device 500 can also include one or more power sources 526, such as when the device is implemented as a wireless device and/or mobile device. The power sources may include a charging and/or power system, and may be implemented as a flexible strip battery, a rechargeable battery, a charged super-capacitor, and/or any other type of active or passive power source.

The example device 500 can also include an audio and/or video processing system 528 that generates audio data for an audio system 530 and/or generates display data for a display system 532. The audio system and/or the display system may include any types of devices or modules that generate, process, display, and/or otherwise render audio, video, display, and/or image data. Display data and audio signals may be communicated to an audio component and/or to a display component via any type of audio and/or video connection or data link. In implementations, the audio system and/or the display system are integrated components of the example device 500. Alternatively, the audio system and/or the display system are external, peripheral components to the example device.

Although implementations for audio manipulation of emulated content have been described in language specific to features and/or methods, the appended claims are not necessarily limited to the specific features or methods described. Rather, the specific features and methods are disclosed as example implementations for audio manipulation of emulated content, and other equivalent features and methods are intended to be within the scope of the appended claims. Further, various different examples are described, and it is to be appreciated that each described example may be implemented independently or in connection with one or more other described examples. Additional aspects of the techniques, features, and/or methods discussed herein relate to one or more of the following:

A media device, comprising a memory configured to store original audio content; and an audio manipulation manager implemented at least partially in hardware, configured to: receive input audio content that emulates the original audio content; receive metadata associated with the original audio content, the metadata including a content creator voice category of the original audio content; determine a user voice category from the input audio content; and transform the input audio content to manipulated audio content by changing the user voice category to the content creator voice category.

Alternatively, or in addition to the above-described media device, any one or combination of: to change the user voice category to the content creator voice category, the audio manipulation manager is configured to change a user tone and a user pitch to a content creator tone and a content creator pitch. The original audio content is a song, and the input audio content is a cover of the song. The audio manipulation manager is configured to detect that the media device is operating in an audio manipulation mode. To detect that the media device is operating in the audio manipulation mode, the audio manipulation manager is configured to: detect an audio application is running in a foreground of the media device; and detect the audio application is requesting use of a microphone of the media device. The audio manipulation manager is configured to identify the original audio content that is emulated by the input audio content. A second content creator voice category is included with the metadata associated with the original audio content; and the audio manipulation manager is configured to change the manipulated audio content from the content creator voice category to the second content creator voice category. The audio manipulation manager is configured to: detect an audio output device is connected to the media device; and communicate the manipulated audio content to the audio output device for audio playback of the manipulated audio content.

A method, comprising: receiving input audio content; identifying original audio content that is emulated by the input audio content; receiving metadata associated with the original audio content, the metadata including a content creator voice category from the original audio content; determining a user voice category from the input audio content; and transforming the input audio content to manipulated audio content by changing the user voice category to the content creator voice category.

Alternatively, or in addition to the above-described method, any one or combination of: changing the user voice category to the content creator voice category includes changing a user tone and a user pitch to a content creator tone and a content creator pitch. The original audio content is a song, and the input audio content is a cover of the song. Identifying the original audio content includes at least one of: accessing an audio application to determine the original audio content; or detecting a tune of the input audio content. A second content creator voice category is included with the metadata associated with the original audio content; and the transforming includes changing the manipulated audio content from the content creator voice category to the second content creator voice category. Detecting an audio manipulation mode by at least one of detecting an audio application is running, or detecting the audio application is requesting the input audio content.

A system, comprising: a processor; and an audio manipulation manager implemented at least partially by the processor, configured to: detect an audio manipulation mode; identify original audio content that is emulated by input audio content; receive a content creator voice category associated with the original audio content; determine a user voice category from the input audio content; and transform the input audio content to manipulated audio content by changing the user voice category to the content creator voice category.

Alternatively, or in addition to the above-described system, any one or combination of: the user voice category includes a user tone and a user pitch, and the content creator voice category includes a content creator tone and a content creator pitch. To change the user voice category to the content creator voice category, the audio manipulation manager is configured to change the user tone to the content creator tone and change the user pitch to the content creator pitch. The original audio content is a song, and the input audio content is a cover of the song. To identify the original audio content, the audio manipulation manager is configured to at least one of: access an audio application to determine the original audio content; or detect a tune of the input audio content. The audio manipulation manager is configured to: receive a second content creator voice category associated with the original audio content; and change the manipulated audio content from the content creator voice category to the second content creator voice category.

1. A media device, comprising:
a memory configured to store original audio content; and
an audio manipulation manager implemented at least partially in hardware, the audio manipulation manager configured to:
receive input audio content that emulates the original audio content;
receive metadata associated with the original audio content, the metadata including a content creator voice category of the original audio content;
determine a user voice category from the input audio content; and
transform the input audio content to manipulated audio content by changing the user voice category to the content creator voice category.

2. The media device of claim 1, wherein to change the user voice category to the content creator voice category, the audio manipulation manager is configured to change a user tone and a user pitch to a content creator tone and a content creator pitch.

3. The media device of claim 1, wherein the original audio content is a song, and the input audio content is a cover of the song.

4. The media device of claim 1 wherein the audio manipulation manager is configured to detect that the media device is operating in an audio manipulation mode.

5. The media device of claim 4, wherein to detect that the media device is operating in the audio manipulation mode, the audio manipulation manager is configured to:
detect an audio application is running in a foreground of the media device; and
detect the audio application is requesting use of a microphone of the media device.

6. The media device of claim 1, wherein the audio manipulation manager is configured to identify the original audio content that is emulated by the input audio content.

7. The media device of claim 1, wherein:
a second content creator voice category is included with the metadata associated with the original audio content; and
the audio manipulation manager is configured to change the manipulated audio content from the content creator voice category to the second content creator voice category.

8. The media device of claim 1, wherein the audio manipulation manager is configured to:
detect an audio output device is connected to the media device; and
communicate the manipulated audio content to the audio output device for audio playback of the manipulated audio content.

9. A method, comprising:
receiving input audio content;
identifying original audio content that is emulated by the input audio content;
receiving metadata associated with the original audio content, the metadata including a content creator voice category from the original audio content;
determining a user voice category from the input audio content; and
transforming the input audio content to manipulated audio content by changing the user voice category to the content creator voice category.

10. The method of claim 9, wherein changing the user voice category to the content creator voice category includes changing a user tone and a user pitch to a content creator tone and a content creator pitch.

11. The method of claim 9, wherein the original audio content is a song, and the input audio content is a cover of the song.

12. The method of claim 9, wherein identifying the original audio content includes at least one of:
accessing an audio application to determine the original audio content; or
detecting a tune of the input audio content.

13. The method of claim 9, wherein a second content creator voice category is included with the metadata associated with the original audio content; and
the transforming includes changing the manipulated audio content from the content creator voice category to the second content creator voice category.

14. The method of claim 9, further comprising:
detecting an audio manipulation mode by at least one of detecting an audio application is running, or detecting the audio application is requesting the input audio content.

15. A system, comprising:
a processor; and
an audio manipulation manager implemented at least partially by the processor, configured to:
detect an audio manipulation mode;
identify original audio content that is emulated by input audio content;
receive a content creator voice category associated with the original audio content;
determine a user voice category from the input audio content; and
transform the input audio content to manipulated audio content by changing the user voice category to the content creator voice category.

16. The system of claim 15, wherein the user voice category includes a user tone and a user pitch, and the content creator voice category includes a content creator tone and a content creator pitch.

17. The system of claim 16, wherein to change the user voice category to the content creator voice category, the audio manipulation manager is configured to change the user tone to the content creator tone and change the user pitch to the content creator pitch.

18. The system of claim 15, wherein the original audio content is a song, and the input audio content is a cover of the song.

19. The system of claim 15, wherein to identify the original audio content, the audio manipulation manager is configured to at least one of:
access an audio application to determine the original audio content; or
detect a tune of the input audio content.

20. The system of claim 15, wherein the audio manipulation manager is configured to:
receive a second content creator voice category associated with the original audio content; and
change the manipulated audio content from the content creator voice category to the second content creator voice category.
